(19) United States
(12) Patent Application Publication
(10) Pub. No.: US 2022/0022417 A1
(43) Pub. Date: Jan. 27, 2022

(54) AUTOMATIC DETECTION OF TREAT RELEASE AND JAMMING WITH CONDITIONAL ACTIVATION OF ANTI-JAMMING IN AN AUTONOMOUS PET INTERACTION DEVICE

(71) Applicant: Go Dogo ApS, Kongens Lyngby (DK)

(72) Inventors: Henrik PETERSEN, Kongens Lyngby (DK); Ole Lim CHRISTIANSEN, Kongens Lyngbyv (DK); Troels Kjeldsen KRISTENSEN, Kongens Lyngbyv (DK); Hanne JARMER, Kongens Lyngby (DK)

(21) Appl. No.: 17/382,266

(22) Filed: Jul. 21, 2021

Related U.S. Application Data
(60) Provisional application No. 63/056,421, filed on Jul. 24, 2020.

(51) Int. Cl. A01K 5/02; A01K 15/02; G06T 7/00; G06N 3/02

(52) U.S. Cl. CPC A01K 5/0291; A01K 15/021; G06T 2207/10016; G06N 3/02; G06T 7/0008

(57) ABSTRACT

Certain aspects of the present disclosure provide techniques for detecting an operational state of an autonomous pet interaction device, including: commanding a treat dispenser to dispense a treat from the autonomous pet interaction device; capturing image data using an image sensor of the autonomous pet interaction device; and determining, based on the image data, whether or not the treat was dispensed from the treat dispenser.

### CROSS-REFERENCE TO RELATED APPLICATIONS

This Application claims the benefit of and priority to U.S. Provisional Patent Application No. 63/056,421, filed on Jul. 24, 2020, the entire contents of which are incorporated herein by reference.

### INTRODUCTION

Aspects of the present disclosure relate to systems and methods for automatically detecting an operational state of a treat release mechanism and conditionally enabling anti-jamming methods in autonomous pet interaction devices.

Domesticated pets are a staple of many homes. Unfortunately, it is not uncommon for caretakers of domesticated pets to spend large amounts of time away from the home, thus leaving the pets home by themselves and generally under-stimulated. This lack of interaction can lead to unhappy and unhealthy pets.

While various products have been conceived for interacting with pets left in a home while their caretakers are away, these products generally have no awareness of their own operational state. For example, if a treat dispenser is meant to react to a certain input (e.g., a prescribed pet behavior or action), but does not because of some operational issue with the treat dispenser, then the pet will soon lose interest and the product will be rendered ineffective. This problem is exacerbated where the product is actually meant to actively stimulate or train a pet in addition to providing basic interaction.

By way of example, when a dog is performing tasks in exchange for treats, it is critical for the dog's continued motivation that a reward is presented when it is earned. If an automatic treat dispenser gets stuck or runs out of treats to dispense, the dog will likely become frustrated and demotivated. By the time the caretaker figures out a problem exists, the dog will have likely become permanently disinterested with the dispenser and thus will permanently lose the benefit of the mental stimulation.

Accordingly, systems and methods are needed to allow an autonomous pet interaction device to automatically detect operational states, such as whether or not a treat was dispensed, and if not, to automatically attempt to correct any operational errors, such as a jam in the dispenser.

### BRIEF SUMMARY

Certain embodiments provide a method for detecting an operational state of an autonomous pet interaction device, including: commanding a treat dispenser to dispense a treat from the autonomous pet interaction device; capturing image data using an image sensor of the autonomous pet interaction device; and determining, based on the image data, whether or not the treat was dispensed from the treat dispenser.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example functional flow diagram for aspects of an autonomous pet interaction device.

FIG. 2 depicts an example functional flow diagram for the logical interaction between the different elements shown in FIG. 1 of an autonomous pet interaction device.

FIG. 3 depicts a front view of an example autonomous pet interaction device.

FIG. 4 depicts a bottom view of the example autonomous pet interaction device.

FIG. 5 depicts a perspective view of the example autonomous pet interaction device.

FIG. 6 depicts an exploded view of aspects of a treat dispenser, including the treat carousel and the carousel holder.

FIG. 7 depicts a cross-sectional view of an example autonomous pet interaction device.

FIG. 8 depicts an enlarged view of a portion of the cross-sectional view depicted in FIG. 7.

FIGS. 9A-9C depict an alternative configuration for holding and dispensing treats from an autonomous pet interaction device.

FIG. 10 depicts an example method for controlling an autonomous pet interaction device.

FIG. 11 depicts an example processing system, which may be configured to control autonomous pet interaction devices as described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically detecting operational states in an autonomous pet interaction device and automatically attempting to correct any operational errors if an error is detected.

Autonomous pet interaction devices, as described herein, may be configured to provide mental stimulation to animals, such as household pets (e.g., dogs and cats), in an automatic, secure, adaptive, and interactive way. In some embodiments, an autonomous pet interaction device may be connected to a display device commonly found in a home, such as a television or computer monitor, to provide auditory and visual instructions and feedback to a pet. Generally, the autonomous pet interaction device may be configured to start with easy cues or instructions that result in a treat being dispensed to a pet upon successful completion.

Because treats may come in many forms, an autonomous pet interaction device may be designed with generalized treat dispensing hardware, which may not always be optimal for certain treats. As such, it is possible that a treat may become “stuck” in a dispensing mechanism. In order to improve on conventional devices, the autonomous pet interaction devices described herein may include various sensors and models configured to detect a “stuck” or otherwise non-conforming operational condition of the autonomous pet interaction device, such as a stuck treat dispenser that is not dispensing treats when commanded.

Notably, embodiments described herein may detect an operational condition even when the autonomous pet interaction device is not experiencing a physical jam. For example, a treat that is stuck inside a dispensing element may fail to be ejected from the dispensing element when commanded, but may not otherwise impact the operation of the device, such as the advancing of a treat carousel comprising many dispensing elements. Similarly, an autonomous pet interaction device may have run out of treats and thus does not dispense a treat when commanded despite being in an otherwise operational state. Conventional devices cannot detect a failure to dispense a treat when the device is otherwise mechanically unaffected.

Generally, autonomous pet interaction devices, as described herein, may have multiple sensing devices (sensors) to detect an operational state of the device.

For example, embodiments described herein may include an image sensor (e.g., a still or live video camera sensor) placed in view of a dispensing path of the device. The image sensor may capture image data, which may include still or moving image data, and provide it to a trained model, such as a machine learning model, to determine whether a treat was dispensed when a treat was expected to be dispensed. For example, the machine learning model may be trained to perform image recognition on the image data to determine whether a treat was detected (e.g., while being dispensed) during a configurable time interval, such as an interval associated with a command to dispense a treat.

Further embodiments may include an audio sensor, such as a microphone, to provide further sensing capabilities and additional data to provide to a sensing model in an autonomous pet interaction device. For example, a machine learning model may be trained to detect the sound of a treat being dispensed based on audio data from an audio sensor. This model may be in addition to, instead of, or integrated with the aforementioned image-based model. For example, a combined model may be configured to output a probability of a treat being dispensed based on the video data and the audio data, or a probability of a treat being dispensed based on the video data separate from a probability of a treat being dispensed based on the audio data. In the latter case, the video-based output and the audio-based outputs (e.g., treat dispensed probabilities) may be used as a voting mechanism to improve fidelity of problem detection.

Other sorts of sensor inputs may be used to detect the successful dispensing of a treat as well. For example, proximity sensors, weight sensors, vibration sensors, and the like may all be used. For example, if a treat is only partially dispensed, a sensor in a treat dispensing carousel of the autonomous pet interaction devices may detect the carousel's failure to move forward partially or fully. As another example, if a treat is dispensed, a vibration associated with the treat falling out of the dispenser may be detected (or not detected if the treat fails to be dispensed). As yet another example, a weight of a treat dispenser (e.g., a carousel) may change when a treat is dispensed. In various embodiments, the output data from one or more of these sorts of sensors may be provided to a trained machine learning model to infer an operational state of the autonomous pet interaction device, such as a state in which treats are being dispensed correctly, and an error state in which treats are not being dispensed correctly. As above, in some cases each input type may be used for an individual model configured for that type of input, whereas in other cases, multiple input types may be combined in a single model architecture. In some cases, models may be ensemble to determine an ultimate determination as to whether a treat was dispensed or not.

Upon detecting a failure to dispense a treat when a treat was meant to be dispensed, the autonomous pet interaction devices described herein may initiate a procedure to correct the operational issue. For example, a second release may be attempted, and the same sensing to determine whether a treat was dispensed on the second attempt may be performed.

If a second attempt fails and/or the autonomous pet interaction device determines (e.g., by a model's output) that a treat has become stuck, the autonomous pet interaction device may engage a treat loosening or dislodging operational mode. For example, in embodiments where the autonomous pet interaction device includes a carousel, the carousel may be instructed to move back and forth a set number of times (e.g., 3 times) in order to try and dislodge or loosen the stuck treat through vibration and perturbation. In some embodiments, a transducer may also be used to vibrate the carousel in order to try and dislodge or loosen the stuck treat (e.g., in addition to commanding the carousel to move).

If automatic attempts to remedy an operational condition preventing treats from being dispensed fail, the autonomous pet interaction device may enter an idle (or error) mode in which interaction with a pet is not offered in order to not encourage the pet without an appropriate treat reward. In some embodiments, the pet may be presented with a cue, such as a visual or audio cue, indicating that the interaction is over. This beneficially prevents the pet from confusing the intended stimulus and response provided by the autonomous pet interaction device.

### Example Computer Vision Algorithms for Determining Operational State of Autonomous Pet Interaction Device

Various computer vision techniques may be used to detect the presence of a treat being dispensed (or not). In one embodiment video frames captured at a sufficiently high frame rate (e.g., >30 FPS) from a forward facing camera (e.g., facing in the direction that a treat will be dispensed) may be used to detect the successful dispensing of treats. In such embodiments, the mean light intensity of video frames are computed over time and the short and long term deviation of the current frame is compared to a certain threshold indicating that a treat passed in front of the camera. Notably, the camera may be adjusted so that a field of view, focal length, aperture, and the like are optimized for detecting change in mean light intensity when a treat is dispensed. In some embodiments, a monochromatic (e.g., greyscale) camera sensor may be used, whereas in others, a color sensor may be used.

In other embodiments the treat detection might be based on the computer vision techniques, such as background subtraction, blob detection, image segmentation, and others.

By continually computing a difference image of the current image and a background image (e.g., either a certain predefined frame, or a more general frame computed by, for example, Gaussian Mixture Models from a given number of previous frames), a binary image can be computed by comparing the pixel differences based on a certain difference threshold value. After performing a certain set of morphological operations on the binary image, it is possible to detect blobs (binary large objects) and from certain properties, such as area and central moments, determine whether a blob corresponds to a treat passing in front of the camera.

In some examples, the aforementioned models configured to detect if a treat is successfully dispensed may be implemented as machine learning models, such as deep neural network models. In such cases, a training data set may be generated based on sensor data captured by autonomous pet interaction device with labelling to indicate in each training instance whether a treat was or was not dispensed.

In some embodiments, the model(s) used by an autonomous pet interaction device may be updateable, such as by software update on the autonomous pet interaction device. For example, an autonomous pet interaction device may include a data port (e.g., USB port) for uploading updated models, or may include a wireless network connection and be configured to receive updated model(s) from a remote service.

In some embodiments, a plurality of autonomous pet interaction devices may be used to perform federated learning of one or more machine learning models for detecting whether a treat was dispensed.

### Example Autonomous Pet Interaction Device Control Logic

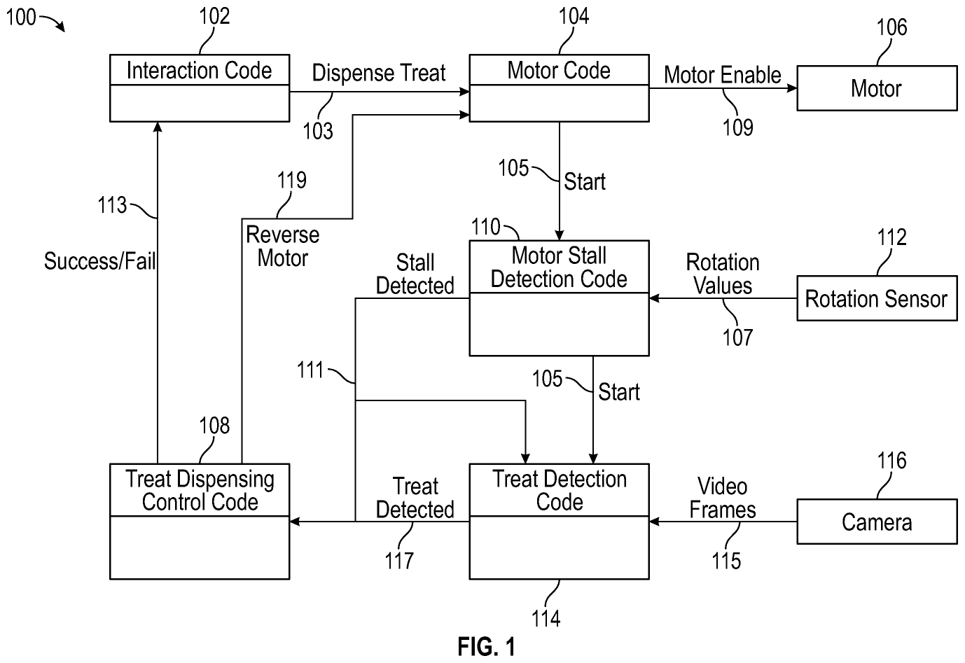

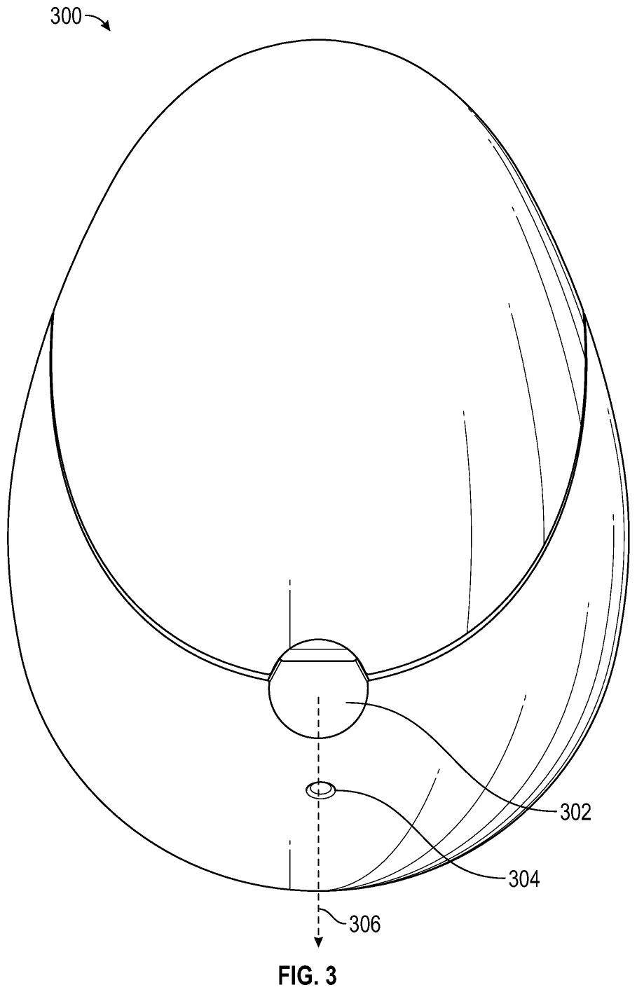

FIG. 1 depicts an example functional flow 100 for aspects of an autonomous pet interaction device. In the depicted example, the motor 106, rotation sensor 112, and camera 116 are hardware components of the autonomous pet interaction device, as further depicted in FIGS. 3-6.

In the depicted example, interaction code 102 represents the logic for how to mentally stimulate an animal (e.g., a pet dog) by providing interactive tasks. The interaction code 102 provides the dispense treat signal 103 when it is determined that the animal successfully performed a given task.

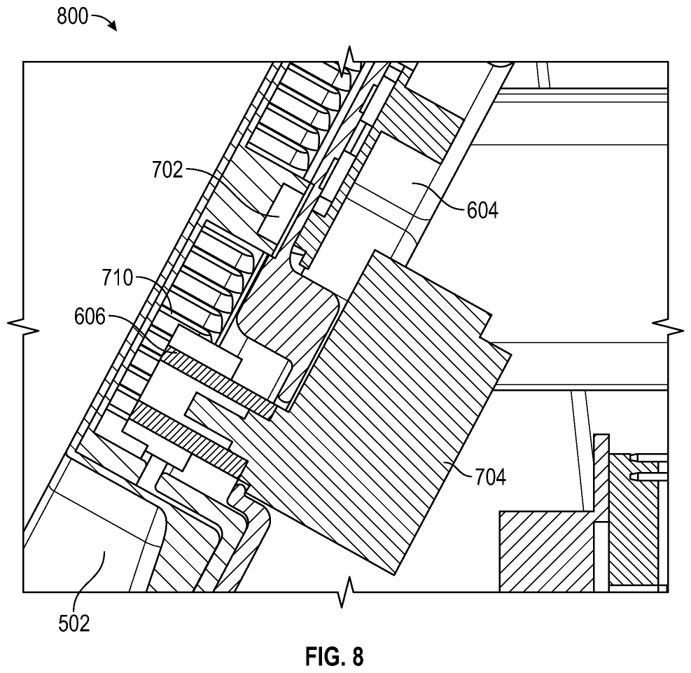

Further in the depicted example, motor code 104 represents the logic for driving the motor 106 that turns a treat carousel (or activates another type of treat dispenser) and thereby releases a treat. The motor 106 may be activated (e.g., turned in one direction or another) by transmitting a motor enable signal 109, which may, for example, activate a general-purpose input/output (GPIO) pin of a main printed circuit board (PCB), as depicted in FIG. 8. The motor code 104 is generally able to control whether the motor 106 turns clockwise or counterclockwise, speeds of the turn, amount of rotation, and the like. After initiating movement of the motor 106, a start signal 105 is sent to the motor stall detection code 110 and treat detection code 114.

Further in the depicted example, motor stall detection code 110 represents the logic for detecting whether the motor 106 is unable to turn (e.g., is stalled), which may indicate whether something has become “stuck|” and is preventing a treat to be dispensed. The stall detection signal 111 may be based on rotation values 107 received from the rotation sensor 112. In some cases, the stall detection signal 111 is a Boolean signal that is input to the treat dispensing control code 108.

Further in the depicted example, treat detection code 114 represents the logic for detecting whether a treat is successfully released. In one embodiment, treat detection code 114 implements a computer vision algorithm to analyze whether a treat passes in front of the camera 116 based on output video frames 115 from camera 116. An output of treat detection code 114 may be treat detected signal 117 that is provided to the treat dispensing control code 108.

Further in the depicted example, treat dispensing control code 108 represents the logic for determining whether the dispense treat signal 103 has resulted in a successfully dispensed treat. In one example, based on the output of the motor stall detection code 110 and the treat detection code 114, treat dispensing control code 108 either outputs a success/fail signal 113 (e.g., a Boolean signal) to the interaction code 102 or a reverse motor signal 119 to the motor code 104 in case a stall has been detected.

Note that in FIG. 1, different “code” elements are depicted separately in order to clearly demonstrate various functions and interactions of an autonomous pet interaction device. The code elements (or more generally components) may be implemented in different manners in other embodiments. For example, one or more of the depicted code elements may be combined, or all of the various code elements may be considered subroutines or subelements of an overarching control code.

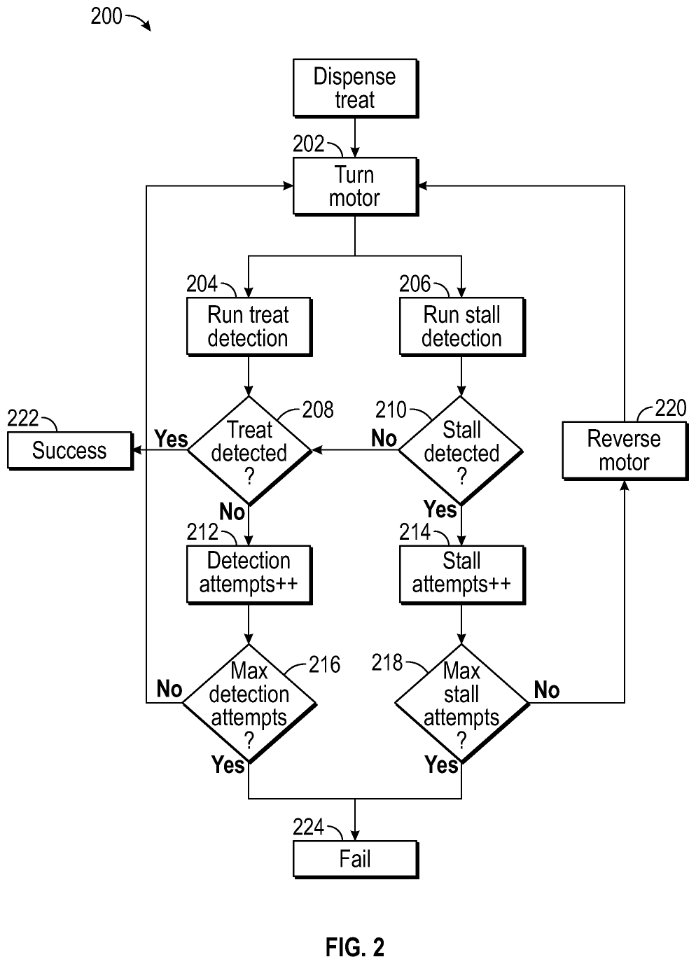

FIG. 2 depicts an example functional flow 200 for the logical interaction between the different elements shown in FIG. 1 of an autonomous pet interaction device.

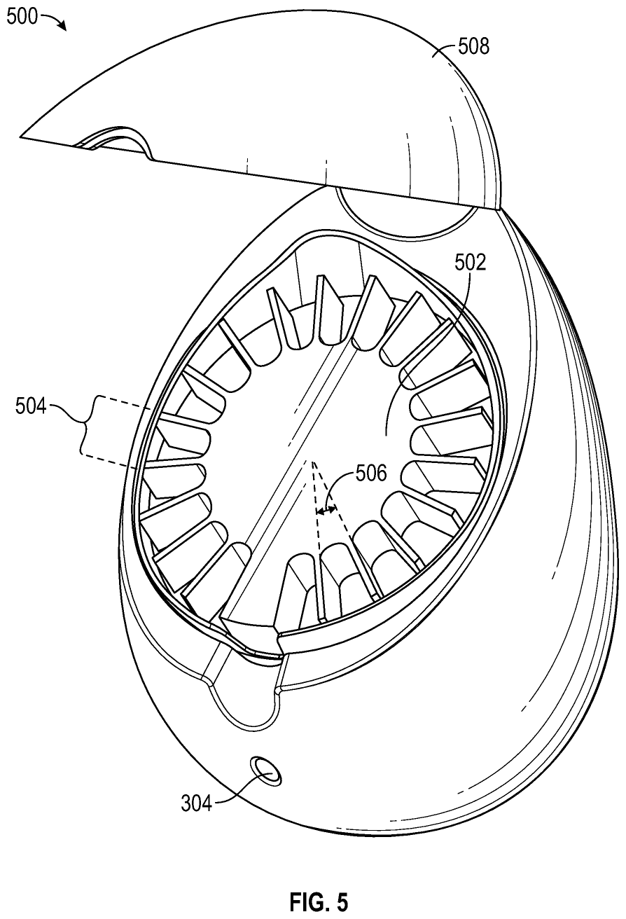

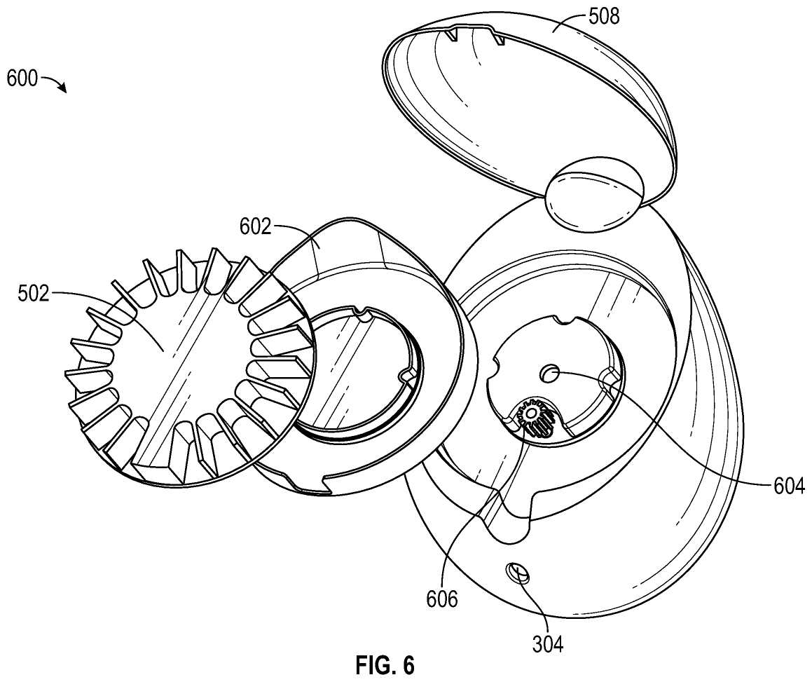

In the depicted example, the logical flow of dispensing a treat starts by providing a signal to turn motor at 202, which may corresponds to turning the motor until a rotation value corresponding to one carousel treat slot (as depicted in FIGS. 5 and 6) is received from the rotation sensor. The treat detection code is then started in parallel with the stall detection code at 204 and 206, respectively.

If a stall is detected at 210, a stall attempts counter (e.g., a variable in a program code) is increased by 1 at 214 and then it is determined whether the stall attempts counter has exceeded a threshold at 218. If not, then the controller attempts to turn the motor first in the reverse direction at 220, and then in the normal direction again back at 202. If the stall is detected again at 210, then the flow 200 continues until no stall is detected at 210 or a maximum number of attempts is reached at 218, and the flow exits with a fail at 224.

If a stall is not detected at 210, then it is determined whether a treat has been detected at 208. If no treat is detected at 208, then a detection attempts counter (e.g., a variable in a program code) is increased by 1 at 212 and then it is determined whether the detection attempts counter has exceeded a threshold at 216. If so, the flow exits with a fail at 224. If not, then the flow 200 returns to turning the motor at 202, which prompts another treat detection at 204.

If at 208 a treat is detected, then the flow exits with a success at 222.

### Example Autonomous Pet Interaction Device with Treat Dispenser

FIGS. 3-9C depict example embodiments of autonomous pet interaction devices with treat dispensers. Generally, a treat dispenser of an autonomous pet interaction device may refer to the aspects of the autonomous pet interaction device that physically dispense a treat, such as a treat dispensing carousel or treat dispensing control arm, which are described in further detail with respect to FIGS. 3-9C.

FIG. 3 depicts a front view 300 of an example autonomous pet interaction device. As depicted, a treat exit 302 is arranged with respect to an image sensor 304 (e.g., a camera) such a treat being dispensed from the treat exit will pass in front of the image sensor 304 along arrow 306 and enable the image sensor 304 to capture image data of the treat if it dispensed correctly.

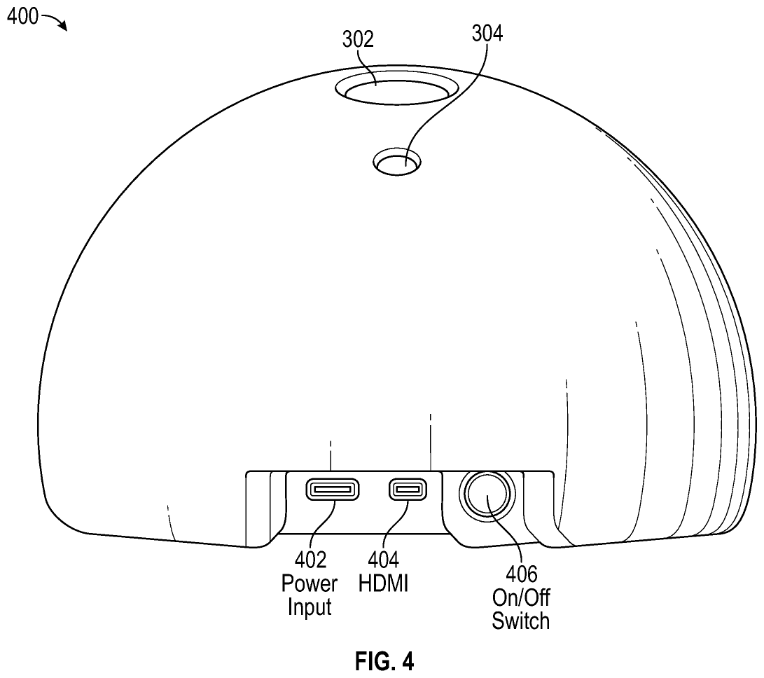

FIG. 4 depicts a bottom view 400 of the example autonomous pet interaction device. In particular, a power input 402, video output 404, and power switch 406 are depicted in addition to the treat exit 302 and image sensor 304 (as in FIG. 3).

FIG. 5 depicts a perspective view 500 of the example autonomous pet interaction device. In the depicted example, a lid (or cover) 508 is depicted in an open position to reveal a treat carousel 502 is shown within a housing of the autonomous pet interaction device. The treat carousel 502 comprises a plurality of volumes (or enclosures) 504 in which treats can be stored for dispensing. As can be seen, each volume 504 may be swept across an angle 506 from the axis of rotation of carousel 502, which may be used by the controller to determine how many degrees to rotate the carousel 502 when dispending treats. Notably, this is just one example of a carousel 502, and others are possible. For example, other carousels may have different numbers, sizes, and shapes of volumes in which treats can be stored.

FIG. 6 depicts an exploded view 600 of aspects of a treat dispenser, including the treat carousel 502 (as described with respect to FIG. 5) and a carousel holder 602. Further, a rotation sensor 604 and gear 606 configured for rotating the treat carousel are depicted.

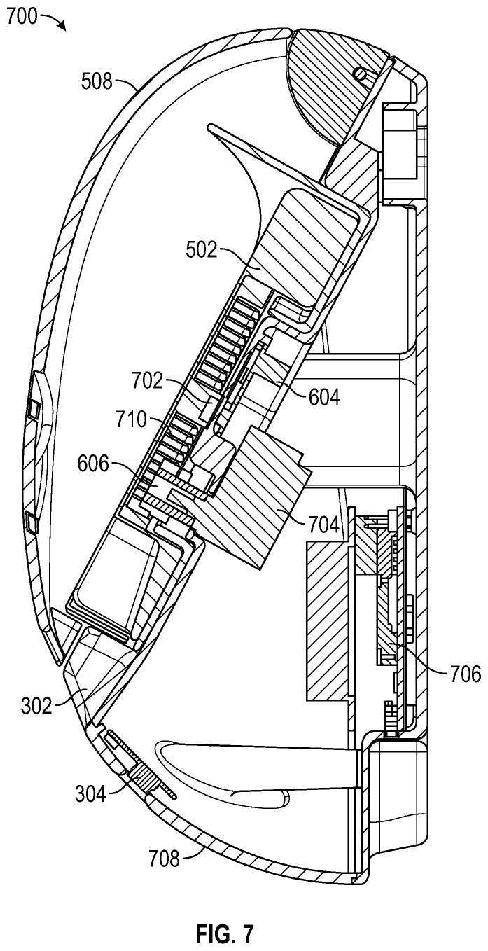

FIG. 7 depicts a cross-sectional view 700 of an example autonomous pet interaction device. In this example, the autonomous pet interaction device includes a rotation sensor 604 and a magnet 702 configured for determining whether the motor 704 and gear 606 are successfully rotating the treat carousel 502. The rotation sensor 604 provides data to a processing system 706 (e.g., a main board or PCB) within the main body 708 of the autonomous pet interaction device, which is configured to control the operation of the motor 606 (e.g., according to the flows FIGS. 1 and 2).

In the depicted example, the autonomous pet interaction device is shown in a configuration to be mounted against a vertical surface, such as a wall, so that a treat may be dispensed by rotating the treat carousel 502 in alignment with the treat exit 302 and allowing the treat to fall out of the autonomous pet interaction device by action of gravity. Further, the treat exit 302 is aligned with the image sensor 304 so that when the treat falls out of the autonomous pet interaction device, it will pass directly in front of the image sensor 304.

The processing system 706 is generally connected to other sub-components, such as the motor 704, the camera 304, and the rotation sensor 604, by suitable electrical connections and configured to control those sub-components, for example, according to the flows in FIGS. 1 and 2.

As above, the image sensor 304 is used, among other things, for the determination of a successful or an unsuccessful treat release. For example, image data from image sensor 304 may be processed by a model stored in a memory of processing system 706.

The motor 704 initiates the rotation of the treat carousel 502, which enables the treat release functionality.

The gear 606 is connected to the motor 704 and interfaces with an internal gear 710 that is located in the treat carousel 502, allows the treat carousel 502 to rotate.

The rotation sensor 604 provides angular rotation feedback to processing system 706, which allows precise control of the angle of treat carousel 502 in order to release only one treat from one carousel treat slot each time. Further, rotation sensor 604 enables processing system 706 to determine when the carousel 502 has made a full rotation and has thus dispensed all the treats.

In the depicted embodiment, rotation sensor 604 interacts with a magnet 702 whose poles are positioned diametrically. In some cases, magnet 702 is a cylindrical, diametrically magnetized magnet. Rotation sensor 604 can read rotation angles when the polarity changes as the treat carousel 502 is rotated about its axis of rotation. The position of the magnet 702 as well as its proximity to the rotation sensor 604 below allows for a precise reading of the rotation angle of treat carousel 502.

FIG. 8 depicts an enlarged view 800 of a portion of the cross-sectional view 700 depicted in FIG. 7. As depicted, the motor 704 provides the rotational torque to the treat carousel 502 through a gear interface between pinion gear 606 and the treat carousel 502 internal gear 710.

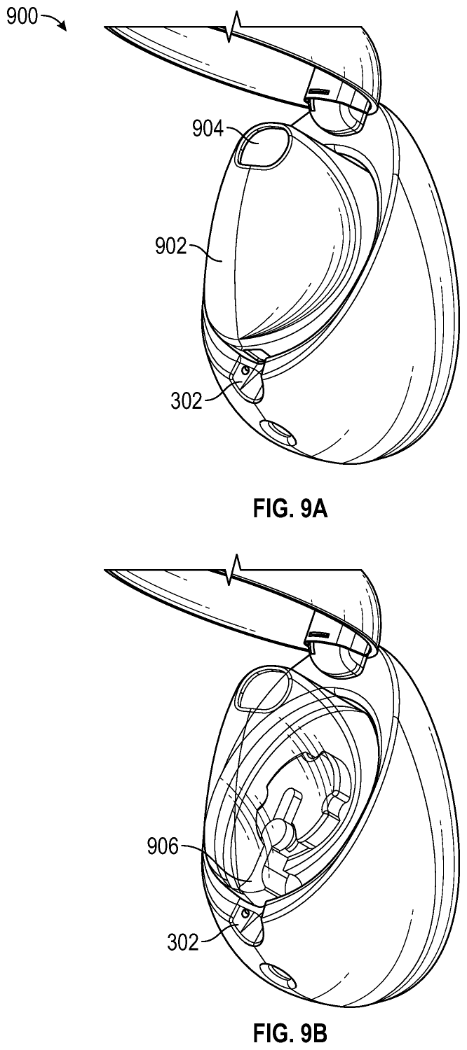

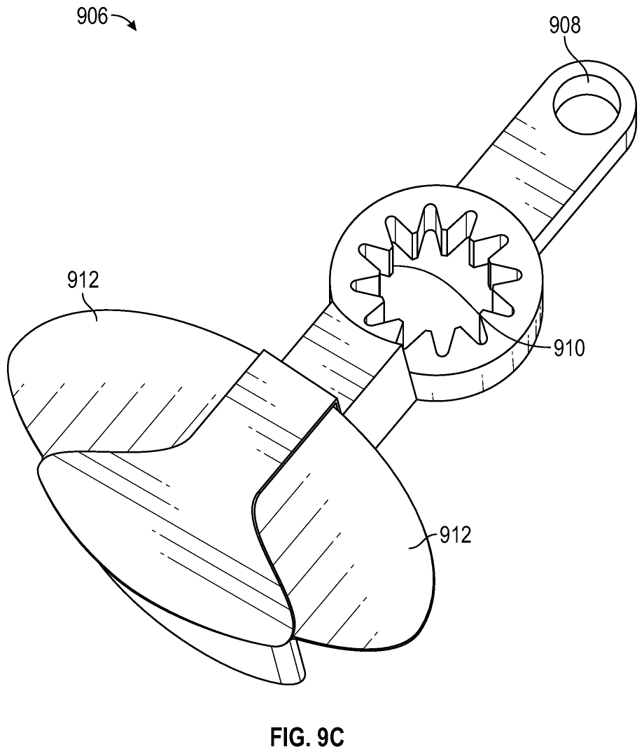

FIGS. 9A-9C depict an alternative configuration for holding and dispensing treats from an autonomous pet interaction device.

As depicted in FIG. 9A, a larger treat container (enclosure) 902 is provided with a treat loading aperture 904. As compared to the treat carousel 502 in FIG. 5, the volume of treats is increased within container 902 and treats are not stored in individual enclosures.

As further depicted in FIG. 9B, a treat dispensing control arm 906, which in this embodiment is shaped like an anchor, is configured to rotate in either direction (e.g., clockwise or counterclockwise) to open and close a path from treat container 902 to treat exit 302. For example, when the treat dispensing control arm 906 moves to unblock treat exit 302, treats are able to fall out of treat exit 302 under the force of gravity.

As depicted in FIG. 9C, the treat dispensing control arm 906 includes a recess 908 for a magnet that moves back and forth over the rotation sensor (e.g., 604 as described above with respect to FIG. 6) to detect movement of the treat dispensing control arm 906. The treat dispensing control arm 906 further includes a recess for accepting the gear 606, so that a motor (e.g., 704 as described above with respect to FIG. 7) can rotate treat dispensing control arm 906. The treat dispensing control arm further includes wings 912 that are configured to unsettle and scoop the treats in order to avoid jamming.

Notably, the motion of treat dispensing control arm 906 may be controlled based on determining whether a treat has been dispensed (e.g., according to flow 100 described above with respect to FIG. 1). In other words, treat dispensing control arm 906 may be moved back and forth until a treat is detected by a processing system (e.g., 706 as described above with respect to FIG. 7).

### Example Method for Controlling an Autonomous Pet Interaction Device

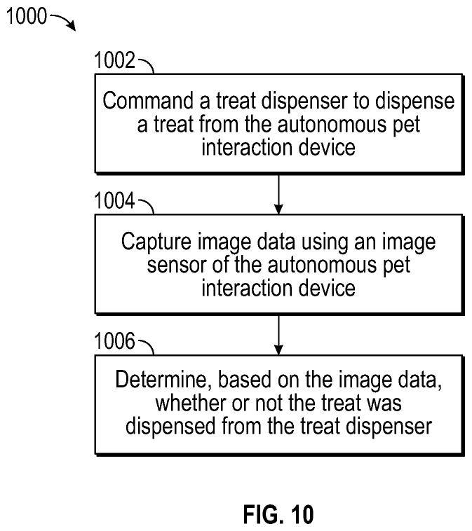

FIG. 10 depicts an example method 1000 for controlling an autonomous pet interaction device. In this example, the operational state may be considered whether the autonomous pet interaction device successfully or unsuccessfully dispensed a treat when commanded.

Method 1000 begins at step 1002 with commanding a treat dispenser to dispense a treat from the autonomous pet interaction device. For example, a dispense treat signal (such as 103 in FIG. 1) may be provided by a control system to cause a motor (e.g., 106 in FIG. 1) to move a treat carousel (e.g., 502 of FIG. 5) or a treat dispensing control arm (e.g., 906 of FIGS. 9A-9C) to dispense a treat.

Method 1000 then proceeds to step 1004 with capturing image data using an image sensor of the autonomous pet interaction device.

Method 1000 then proceeds to step 1006 with determining, based on the image data, whether or not the treat was dispensed from the treat dispenser.

In some embodiments of method 1000, determining, based on the image data, whether or not the treat was dispensed from the treat dispenser comprises: providing the image data to a model; and receiving from the model a determination of whether or not the treat was dispensed. In some embodiments, the model is a deep neural network model and the image sensor is a video image sensor.

Though not depicted in FIG. 10, method 1000 may further include entering a mode configured to dislodge a stuck treat upon determining, based on the image data, that the treat was not dispensed from the treat dispenser. For example, method 1000 may further include rotating a carousel (e.g., 502 of FIG. 5) or treat dispensing control arm (e.g., 906 of FIGS. 9A-9C) in a first direction and a then second direction, different from the first direction, a plurality of times in order to dislodge the treat.

In some embodiments, method 1000 may further include entering a normal state if rotating the carousel or the treat dispensing control arm dislodged the treat; and entering a disabled state if rotating the carousel or the treat dispensing control arm did not dislodge the treat. A normal state may generally describe a state in which the device is operating normally, such as interacting with an animal and dispensing treats based on that interaction. A disable state, on the other hand, may generally describe a state in which the device has stopped interacting with the animal and is not attempting to dispense treats.

In some embodiments, method 1000 may further include determining based on rotation sensor data whether or not the carousel or the treat dispensing control arm of the treat dispenser rotated after commanding the treat dispenser to dispense the treat.

In some embodiments, method 1000 may further include reversing a rotation direction of the treat dispenser after determining based on the rotation sensor data that the carousel of the treat dispenser did not rotate after commanding the treat dispenser to dispense a treat.

Note that method 1000 is just one example, and many other examples, which may include additional, alternative, or fewer steps, are possible consistent with this disclosure.

### Example Processing System for an Autonomous Pet Interaction Device

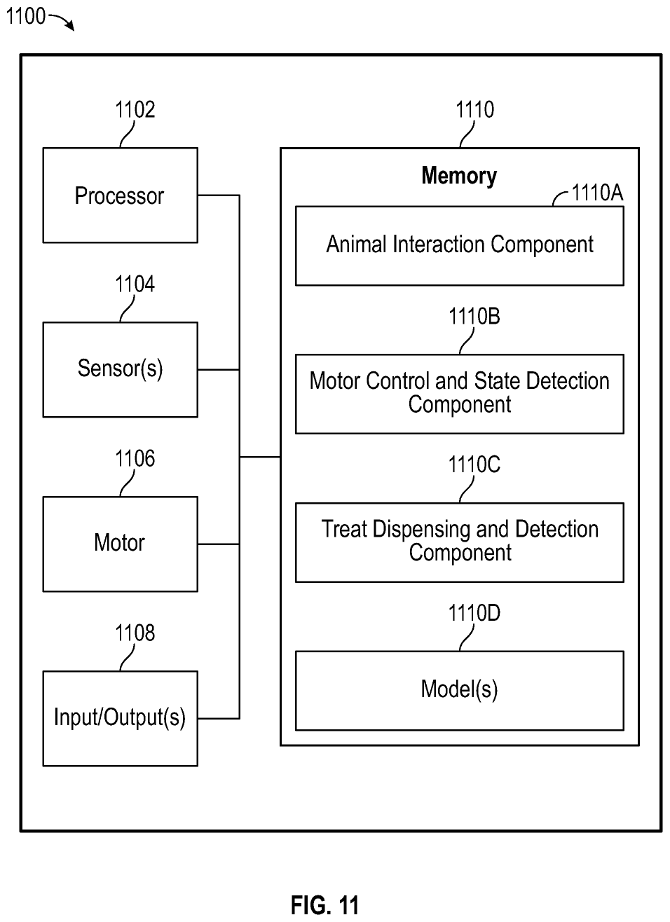

FIG. 11 depicts an example processing system 1100, which may be configured to control an autonomous pet interaction device, such as those described with respect to FIGS. 3-9C, according to methods and functional flows, such as those described with respect to FIGS. 1, 2, and 10.

In the depicted embodiment, processing system 1100 includes processor 1102, which may be a general purpose processor, a microcontroller, an application-specific integrated circuit (ASIC), a field programmable gate array (FPGA), and the like.

Processor 1102 is configured to receive data from sensors 1104, which may include an image sensor (e.g., 304 as described with respect to FIG. 3), such as a video senor, as well as a rotation sensor (e.g., 604 as described with respect to FIG. 3). Sensors 1104 may further include an audio sensor, a proximity sensor, a weight sensor, a vibration sensor, and others as described herein.

Processor 1102 is further configured to control motor 1106, which may in-turn rotate a treat dispenser, as described herein (e.g., as described with respect to motor 704 of FIG. 7).

Processor 1102 is further configured to receive data from and send data to various input and output interfaces 1108. For example, processor 1102 may output video and audio signals through an audio/visual interface, such as HDMITM interface 404 as depicted in FIG. 4. Input and output interfaces 1108 may also include networking interfaces, such as wireless network interfaces (e.g., Wi-Fi) in order to send and receive data over networks, including the Internet.

Processor 1102 is further configured to execute computer executable code in memory 1110, which implement functional components. For example, processor 1102 is further configured to execute an animal interaction component 1110A, such as described with respect to code 102 in FIG. 1. Processor 1102 is further configured to execute a motor control and state detection component 1110B, such as described with respect to code 104 and 110 in FIG. 1. Processor 1102 is further configured to execute a treat dispensing and detection component 1110C, such as described with respect to code 108 and 114 in FIG. 1.

Processor 1102 is further configured to execute models 1110D, which may include machine learning models for detecting treats, as described above, and which may be used by treat dispensing and detection component 1110C.

In some embodiments, processor 1102 is configured to implement the flows of FIGS. 1 and 2, as described above.

Note that processing system 1100 is just one example depicting selected aspects for simplicity and clarity, and other processing systems are possible consistent with the description herein.

### Example Clauses

Implementation examples are described in the following numbered clauses:

Clause 1: A method for controlling an autonomous pet interaction device, comprising: commanding a treat dispenser to dispense a treat from the autonomous pet interaction device; capturing image data using an image sensor of the autonomous pet interaction device; and determining, based on the image data, whether or not the treat was dispensed by the treat dispenser.

Clause 2: The method of Clause 1, wherein determining, based on the image data, whether or not the treat was dispensed from the treat dispenser comprises: providing the image data to a model; and receiving from the model a determination of whether or not the treat was dispensed.

Clause 3: The method of Clause 2, wherein: the model is a deep neural network model, and the image sensor is a video image sensor.

Clause 4: The method of any one of Clauses 1-3, further comprising entering a mode configured to dislodge a stuck treat upon determining, based on the image data, that the treat was not dispensed from the treat dispenser.

Clause 5: The method of Clause 4, further comprising rotating one of a carousel or a control arm of the treat dispenser in a first direction and a then second direction, different from the first direction, a plurality of times in order to dislodge the treat.

Clause 6: The method of Clause 5, further comprising: entering a normal state if rotating the carousel or the control arm dislodges the treat; and entering a disabled state if rotating the carousel or the control arm does not dislodge the treat.

Clause 7: The method of any one of Clauses 1-6, further comprising determining based on rotation sensor data whether or not a carousel or a control arm of the treat dispenser rotated after commanding the treat dispenser to dispense the treat.

Clause 8: The method of Clause 7, further comprising reversing a rotation direction of the treat dispenser after determining based on the rotation sensor data that the carousel or the control arm of the treat dispenser did not rotate after commanding the treat dispenser to dispense a treat.

Clause 9: The method of any one of Clauses 1-8, wherein the treat dispenser comprises a treat carousel configured to hold treats in a plurality of treat enclosures.

Clause 10: The method of any one of Clauses 1-8, wherein the treat dispenser comprises a treat dispensing control arm configured to selectively block or unblock a treat exit.

Clause 11: An autonomous pet interaction device, comprising: a treat dispenser; a motor configured to rotate the treat dispenser; an image sensor configured to capture image data of a treat being dispensed from the treat dispenser; a memory comprising computer-executable code; and a processor configured to cause the autonomous pet interaction device to: command the treat dispenser to dispense a treat from the autonomous pet interaction device; capture image data using the image sensor; and determine, based on the image data, whether or not the treat was dispensed by the treat dispenser.

Clause 12: The autonomous pet interaction device of Clause 11, wherein in order to determine, based on the image data, whether or not the treat was dispensed from the treat dispenser, the processor is further configured to: provide the image data to a model; and receive from the model a determination of whether or not the treat was dispensed.

Clause 13: The autonomous pet interaction device of Clause 12, wherein: the model is a deep neural network model, and the image sensor is a video image sensor.

Clause 14: The autonomous pet interaction device of any one of Clauses 11-13, wherein the processor is further configured to cause the autonomous pet interaction device to enter a mode configured to dislodge a stuck treat upon a determination, based on the image data, that the treat was not dispensed from the treat dispenser.

Clause 15: The autonomous pet interaction device of Clause 14, wherein the processor is further configured to cause the autonomous pet interaction device to rotate one of a carousel or a control arm of the treat dispenser in a first direction and a then second direction, different from the first direction, a plurality of times in order to dislodge the treat.

Clause 16: The autonomous pet interaction device of Clause 15, wherein the processor is further configured to cause the autonomous pet interaction device to: enter a normal state if rotating the carousel or the control arm dislodges the treat; and enter a disabled state if rotating the carousel or the control arm does not dislodge the treat.

Clause 17: The autonomous pet interaction device of any one of Clauses 11-16, wherein the processor is further configured to cause the autonomous pet interaction device to determine based on rotation sensor data whether or not a carousel or a control arm of the treat dispenser rotated after commanding the treat dispenser to dispense the treat.

Clause 18: The autonomous pet interaction device of Clause 17, wherein the processor is further configured to cause the autonomous pet interaction device to reverse a rotation direction of the treat dispenser after a determination based on the rotation sensor data that the carousel or the control arm of the treat dispenser did not rotate after commanding the treat dispenser to dispense a treat.

Clause 19: The autonomous pet interaction device of any one of Clauses 11-18, wherein the treat dispenser comprises a treat carousel configured to hold treats in a plurality of treat enclosures.

Clause 20: The autonomous pet interaction device of any one of Clauses 11-18, wherein the treat dispenser comprises a treat dispensing control arm configured to selectively block or unblock a treat exit.

Clause 21: A processing system, comprising: a memory comprising computer-executable instructions; one or more processors configured to execute the computer-executable instructions and cause the processing system to perform a method in accordance with any one of Clauses 1-10.

Clause 22: A processing system, comprising means for performing a method in accordance with any one of Clauses 1-10.

Clause 23: A non-transitory computer-readable medium comprising computer-executable instructions that, when executed by one or more processors of a processing system, cause the processing system to perform a method in accordance with any one of Clauses 1-10.

Clause 24: A computer program product embodied on a computer-readable storage medium comprising code for performing a method in accordance with any one of Clauses 1-10.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for controlling an autonomous pet interaction device, comprising:
commanding a treat dispenser to dispense a treat from the autonomous pet interaction device;
capturing image data using an image sensor of the autonomous pet interaction device; and
determining, based on the image data, whether or not the treat was dispensed by the treat dispenser.

2. The method of claim 1, wherein determining, based on the image data, whether or not the treat was dispensed from the treat dispenser comprises:
providing the image data to a model; and
receiving from the model a determination of whether or not the treat was dispensed.

3. The method of claim 2, wherein:
the model is a deep neural network model, and
the image sensor is a video image sensor.

4. The method of claim 1, further comprising entering a mode configured to dislodge a stuck treat upon determining, based on the image data, that the treat was not dispensed from the treat dispenser.

5. The method of claim 4, further comprising rotating one of a carousel or a control arm of the treat dispenser in a first direction and a then second direction, different from the first direction, a plurality of times in order to dislodge the treat.

6. The method of claim 5, further comprising:
entering a normal state if rotating the carousel or the control arm dislodges the treat; and
entering a disabled state if rotating the carousel or the control arm does not dislodge the treat.

7. The method of claim 1, further comprising determining based on rotation sensor data whether or not a carousel or a control arm of the treat dispenser rotated after commanding the treat dispenser to dispense the treat.

8. The method of claim 7, further comprising reversing a rotation direction of the treat dispenser after determining based on the rotation sensor data that the carousel or the control arm of the treat dispenser did not rotate after commanding the treat dispenser to dispense a treat.

9. The method of claim 1, wherein the treat dispenser comprises a treat carousel configured to hold treats in a plurality of treat enclosures.

10. The method of claim 1, wherein the treat dispenser comprises a treat dispensing control arm configured to selectively block or unblock a treat exit.

11. An autonomous pet interaction device, comprising
a treat dispenser;
a motor configured to rotate the treat dispenser;
an image sensor configured to capture image data of a treat being dispensed from the treat dispenser;
a memory comprising computer-executable code; and
a processor configured to cause the autonomous pet interaction device to:
command the treat dispenser to dispense a treat from the autonomous pet interaction device;
capture image data using the image sensor; and
determine, based on the image data, whether or not the treat was dispensed by the treat dispenser.

12. The autonomous pet interaction device of claim 11, wherein in order to determine, based on the image data, whether or not the treat was dispensed from the treat dispenser, the processor is further configured to:
provide the image data to a model; and
receive from the model a determination of whether or not the treat was dispensed.

13. The autonomous pet interaction device of claim 12, wherein:
the model is a deep neural network model, and
the image sensor is a video image sensor.

14. The autonomous pet interaction device of claim 11, wherein the processor is further configured to cause the autonomous pet interaction device to enter a mode configured to dislodge a stuck treat upon a determination, based on the image data, that the treat was not dispensed from the treat dispenser.

15. The autonomous pet interaction device of claim 14, wherein the processor is further configured to cause the autonomous pet interaction device to rotate one of a carousel or a control arm of the treat dispenser in a first direction and a then second direction, different from the first direction, a plurality of times in order to dislodge the treat.

16. The autonomous pet interaction device of claim 15, wherein the processor is further configured to cause the autonomous pet interaction device to:
enter a normal state if rotating the carousel or the control arm dislodges the treat; and
enter a disabled state if rotating the carousel or the control arm does not dislodge the treat.

17. The autonomous pet interaction device of claim 11, wherein the processor is further configured to cause the autonomous pet interaction device to determine based on rotation sensor data whether or not a carousel or a control arm of the treat dispenser rotated after commanding the treat dispenser to dispense the treat.

18. The autonomous pet interaction device of claim 17, wherein the processor is further configured to cause the autonomous pet interaction device to reverse a rotation direction of the treat dispenser after a determination based on the rotation sensor data that the carousel or the control arm of the treat dispenser did not rotate after commanding the treat dispenser to dispense a treat.

19. The autonomous pet interaction device of claim 11, wherein the treat dispenser comprises a treat carousel configured to hold treats in a plurality of treat enclosures.

20. The autonomous pet interaction device of claim 11, wherein the treat dispenser comprises a treat dispensing control arm configured to selectively block or unblock a treat exit.
